(19) United States
(12) Patent Application Publication
(10) Pub. No.: US 2003/0188725 A1
(43) Pub. Date: Oct. 9, 2003

(54) Fluid cooling apparatus for a combustion system

(76) Inventor: John Van Winkle, Walton, KY (US)

Correspondence Address: TAFT, STETTINIUS & HOLLISTER LLP, SUITE 1800, 425 WALNUT STREET, CINCINNATI, OH, 45202-3957, US

(21) Appl. No.: 10/176,382

(22) Filed: Jun. 20, 2002

Related U.S. Application Data
(60) Provisional application No. 60/370,090, filed on Apr. 4, 2002.

(51) Int. Cl. F02M 15/00

(52) U.S. Cl. 123/542

(57) ABSTRACT

An apparatus for carrying out a method for transferring thermal energy in relation to a gas traveling through a gas intake to an internal combustion engine, comprising the steps of: providing at least one thermoelectric device having at least two surfaces, concurrently dissipating thermal energy on a warmer surface and absorbing thermal energy on a cooler surface; and establishing a thermal gradient between the gas within the gas intake to the internal combustion engine and the cooler surface of the thermoelectric device.

### CROSS-REFERENCE TO RELATED APPLICATION

This application claims the benefit of U.S. Provisional Application No. 60/370,090, entitled “AIR COOLING APPARATUS FOR A COMBUSTION SYSTEM”, filed on Apr. 4, 2002.

### BACKGROUND

1. Field of the Invention

The present invention relates to a thermal energy exchanger for a gas conduit providing cooled gases to the combustion chamber of an internal combustion engine and associated methods of use and manufacture. More particularly, the invention is directed to gas conduit thermal energy exchangers adapted to be used with turbochargers, utilizing commercially available thermoelectric heat transfer devices that have the capability to concurrently provide heating and cooling on opposing sides of the device.

2. Description of the Related Art

The heating and/or cooling of fluids in transit or at a point of accumulation has been effectuated in a multitude of fashions dating back as far as the origin of the very reasons for such heat transfer. Older pieces of art typically center around heat transfer from or to a fluid by the circulation of currents from one region to another, or by the emission and propagation of energy in the form of rays or waves.

More specifically, in the area of internal combustion engines, it is well known in the art that cooling the air before the air enters the combustion chamber reduces the exhaust temperature and provides for more complete combustion. So-called “intercoolers” have been developed to cool the air entering the combustion chamber using numerous methods such as using the vehicle's radiator fluid or using the ambient air. The problem associated with most of these methods and apparatuses which cool the air entering the combustion chamber is that the temperature of the air never gets below the temperature of the ambient environment because when the radiator fluid or simply flowing air is used for thermal energy transfer, the temperature of the radiator fluid or air is the lower limit. These intercoolers find particular application when placed downstream from turbochargers. Turbochargers effectively increase the density of the air entering the combustion chamber, with the drawback of increased temperature of the air. The combustion of fuels is generally more efficient with a higher density of oxygen being available at a lower temperature. Thus, turbochargers provide one advantage (more oxygen for combustion), while presenting a drawback (higher temperature oxygen).

### SUMMARY OF THE INVENTION

The present invention relates to a thermal energy exchanger for a gas conduit providing cooled gases to the combustion chamber of an internal combustion engine and associated methods of use and manufacture. The invention may utilize one or more thermoelectric devices (CWTD) manufactured from two ceramic wafers and a series of “P & N” doped semiconductor blocks sandwiched therebetween to form a bank of thermoelectric devices capable of concurrent thermal energy absorption and dissipation on the opposing surfaces.

The invention utilizes this concurrent thermal energy absorption and dissipation on opposing surfaces to create thermal gradients between the gas within the conduit and one of either the absorption or dissipation surfaces. The temperature of the gas and the temperature of the respective surface of the CWTD may be the points of reference for determining the thermal energy gradient. So long as the mean temperature of the cooler surface is less than that of the gas, thermal energy will be drawn from the gas and absorbed by the cooler surface, thereby cooling the gas within the conduit. In some applications it may not be desired to have the thermoelectric device come into direct contact with the gas. In these examples, the thermoelectric device may not necessarily be in direct contact with the air, but may be positioned such that thermal energy may be exchanged between the gas and at least one surface of the thermoelectric device.

More specifically, the thermoelectric devices may be positioned in such a manner so as to cool the gas before it enters the combustion chamber of an internal combustion engine. In an illustrative example, air from the atmosphere enters an air intake conduit where it may be cooled according to the present invention before being directed into the combustion chamber with a fuel before ignition. Alternatively, the air may pass through a turbocharger which creates a pressure differential between the air intake and the combustion chamber, thereby increasing the amount of air which enters the combustion chamber via pressurization. In these examples, thermal communication by direct contact or through a heat exchange medium allows for the exchange of thermal energy between the air and at least one surface of the CWTD. In certain exemplary embodiments, the cooler surface of the CWTD(s) is in thermal communication with an external surface of a conduit, which is in thermal communication with the contained air passing therethrough. The process of thermal energy transfer from the contained air to the warmer surface of the CWTD(s) in a cooling operation includes: thermal energy leaving the air and being absorbed by the material of the conduit; thermal energy leaving the conduit material and being absorbed by the cooler surface of the thermoelectric device (CWTD); and, thermal energy being moved or pumped, from the cooler surface along with thermal energy produced from the resistance to current flow, to the warmer surface of the thermoelectric device (CWTD). Alternatively, the apparatus may be utilized to cool fluids other than air that are directed into the combustion chamber of an internal combustion engine.

Advantageously, the CWTDs operate on relatively low power and voltages and are relatively durable. Because the CWTDs dissipate thermal energy on the side (warming side) of the device opposite that of the cooling side (absorbing heat), the above described exemplary embodiments of the invention may utilize a heat sink to improve dissipation of thermal energy from the warming side.

It is a first aspect of the present invention to provide an apparatus for transferring thermal energy in relation to a gas traveling through a gas intake of an internal combustion engine, the apparatus comprising: a gas intake conduit adapted to be utilized as a conduit for gas traveling to a combustion chamber of an engine; at least one thermoelectric device having at least two surfaces, concurrently dissipating thermal energy on a warmer surface and absorbing thermal energy on a cooler surface, mounted in proximity to the gas intake conduit and providing thermal communication between the gas intake conduit and the cooler surface of the thermoelectric device, and; a heat sink in thermal communication with the warmer surface.

It is a second aspect of the present invention to provide an apparatus for transferring thermal energy in relation to a gas traveling through a gas intake conduit of an engine, the apparatus comprising: a first bank of thermoelectric devices having opposed cooling surfaces and heating surfaces, the cooling surfaces absorbing thermal energy while the heating surfaces are concurrently dissipating thermal energy; a first interface block of heat transfer material adapted to be mounted in thermal communication with an inner surface of the gas intake conduit, the interface block having a surface receiving the cooling surfaces of the first bank of thermoelectric devices, and; a first heat sink mounted in thermal communication with the heating surfaces of the first bank of thermoelectric devices.

It is a third aspect of the present invention to provide an apparatus for shifting thermal energy collateral to a flowing gas, the apparatus comprising: a first bank of thermoelectric devices having opposed cooling surfaces and heating surfaces, the cooling surfaces absorbing thermal energy while the heating surfaces are concurrently dissipating thermal energy, and; a clamp mounted so as to enable thermal communication between the first bank of thermoelectric devices and a gas approaching a combustion chamber of an engine.

It is a fourth aspect of the present invention to provide a method for transferring thermal energy in relation to a gas traveling through a gas intake to an engine, the method comprising the steps of: providing at least one thermoelectric device having at least two surfaces, concurrently dissipating thermal energy on a warmer surface and absorbing thermal energy on a cooler surface when powered; positioning the thermoelectric device to be in thermal communication with a gas intake conduit for the engine, and; providing power to the thermoelectric device to establish a thermal gradient between a gas within the gas intake conduit and the cooler surface of east the one thermoelectric device.

It is a fifth aspect of the present invention to provide a method for transferring thermal energy in relation to a gas traveling through a gas intake of an engine, the method comprising the steps of: providing a gas intake conduit for gas flowing to a combustion chamber of an internal combustion engine; providing at least one thermoelectric device having at least two surfaces, concurrently dissipating thermal energy on a warmer surface and absorbing thermal energy on a cooler surface when powered; mounting the thermoelectric device such that the cooler surface is in thermal communication with the gas intake conduit; providing a heat sink to be in thermal communication with at least the warmer surface of the thermoelectric device; supplying a flowing fluid in proximity to the heat sink, and; providing power to at least the one thermoelectric device to establish a thermal gradient between a gas within the gas intake conduit and the cooler surface of at least the one thermoelectric device.

It is a sixth aspect of the present invention to provide a method for transferring thermal energy from a gas traveling downstream from a turbocharger of a combustion system, the method comprising the steps of: providing at least one thermoelectric device having at least two surfaces, concurrently dissipating thermal energy on a warmer surface and absorbing thermal energy on a cooler surface when powered; positioning the thermoelectric device to be in thermal communication with a gas intake conduit section downstream from the turbocharger of the combustion system, and; providing power to at least the one thermoelectric device to establish a thermal gradient between a gas within the downstream section of the gas intake conduit and the cooler surface of at least the one thermoelectric device.

It is a seventh aspect of the present invention to provide a method for transferring thermal energy from a gas traveling upstream from a combustion section of an internal combustion engine, the method comprising the steps of: providing at least one thermoelectric device having at least two surfaces, concurrently dissipating thermal energy on a warmer surface and absorbing thermal energy on a cooler surface when powered; positioning the thermoelectric device to be in thermal communication with a gas intake conduit section upstream from the combustion section of the internal combustion engine, and; providing power to thee thermoelectric device to establish a thermal gradient between a gas within the upstream section of the gas intake conduit and the cooler surface of the thermoelectric device.

It is an eighth aspect of the present invention to provide a method for transferring thermal energy from a gas traveling upstream from a combustion section of a vehicle combustion system, the method comprising the steps of: providing a gas intake conduit upstream from a combustion system of a vehicle combustion system for directing a gas into the combustion section; providing at least two thermoelectric devices, each having at least two surfaces, concurrently dissipating thermal energy on a warmer surface and absorbing thermal energy on a cooler surface when powered; mounting the thermoelectric devices such that the cooler surfaces are in thermal communication with the gas intake conduit; providing at least a first heat sink to be in thermal communication with the warmer surface of at least one of the thermoelectric devices; supplying a flowing fluid in proximity to the heat sink, and; providing power to the thermoelectric devices to establish a thermal gradient between the gas within the gas intake conduit and the cooler surface of the thermoelectric device.

It is a ninth aspect of the present invention to provide a method for transferring thermal energy in relation to a gas traveling through a gas intake to an internal combustion engine, comprising the steps of: providing at least one thermoelectric device having at least two surfaces, concurrently dissipating thermal energy on a warmer surface and absorbing thermal energy on a cooler surface, and; establishing a thermal gradient between the gas within the gas intake to the internal combustion engine and the cooler surface of the thermoelectric device.

### BRIEF DESCRIPTION OF THE DRAWINGS

FIG. 1 is a side view of a first exemplary embodiment of the present invention.

FIG. 2 is a side view of a second exemplary embodiment of the present invention.

FIG. 3 is a partial schematic of a control system for use with the exemplary embodiments of the present invention.

FIG. 4 is a frontal view of a third exemplary embodiment of the present invention.

FIG. 5 is a frontal view of a fourth exemplary embodiment of the present invention.

FIG. 6 is an frontal view of a fifth exemplary embodiment of the present invention.

### DETAILED DESCRIPTION OF THE PREFERRED EMBODIMENTS

The present invention provides a thermal energy exchanger for a gas conduit providing cooled gases to the combustion chamber of an internal combustion engine and associated methods of use and manufacture. The apparatuses, methods and systems described below are exemplary in nature and are not intended to constitute limits upon the present invention.

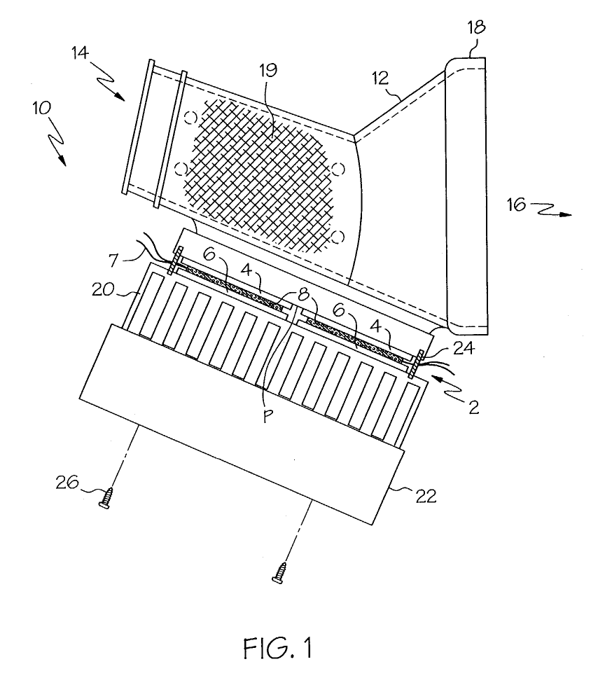

The exemplary embodiments of the present invention utilize one or more commercially-available ceramic wafered thermoelectric devices (CWTDs) that have opposed ceramic surfaces. Upon activation of the CWTDs, one of the ceramic surfaces becomes heated while the opposing ceramic surfaces becomes cooled. For example, as shown in FIG. 1, the CWTDs 2 in the exemplary embodiments, utilize two thin ceramic wafers 4, 6 with a series of bismuth telluride semi-conductor blocks 8 sandwiched therebetween that are sufficiently doped to exhibit an excess of electrons (P) or a deficiency of electrons (N). The wafer material provides an electrically-insulated and mechanically rigid support structure for the thermoelectric device. The “P & N” type semiconductor blocks are electrically interconnected such that, upon electrical activation, and depending upon the polarity, heat is transferred from one ceramic wafer to the opposite wafer causing one ceramic wafer 4 to become cooled while the opposing ceramic wafer 6 becomes hot. The CWTDs 2 are commercially available, for example, as CP2-127-06L from Melcor Corporation, Trenton, N.J. (www.melcor.com).

CWTD 2 has leads 7 which provide direct current in the “J” direction to the CWTDs 2, thereby making one wafer 6 warmer in comparison to the other wafer 4 which is cooler. Upon switching of the leads and directing current in the opposite direction, “−J”, the one wafer 6 now becomes the cooler wafer and the other wafer 4 becomes the warmer wafer. This flexibility enables the opposing wafers 4, 6 of the CWTD 2 to change their character (heating to cooling or cooling to heating) simply by changing the direction of direct current flow. The following exemplary embodiments will be explained using the wafer 4 as the cooler wafer, while the wafer 6 will be referred to as the warmer wafer; it will be apparent to those of ordinary skill, however, that, upon switching polarity of the direct current, the wafer 4 will be a heating wafer and wafer 6 will be a cooling wafer.

A first exemplary embodiment of a thermal energy exchanger 10 is shown in FIG. 1. The thermal energy exchanger 10 includes an air intake conduit 12, having a warm air inlet 14 and cool air outlet 16, that may be connected, for example, to the air intake 18 of an internal combustion engine. The air intake conduit 12 may have an exterior shape with one or more planar surfaces adapted to mount CWTDs 2 to the surface. Interior cross-sections of the air intake conduit 12 may exhibit a circular or noncircular cross-section. The thermal energy exchanger 10 may include heat transfer fixtures, such as metal or wire mesh 19, for example, that are placed within the air intake conduit 12 and into contact with the walls of the air intake conduit 12 and air flowing therein. These fixtures 19 help provide or maintain turbulent air flow within the air intake conduit 12 and increase the surface area of the heat transfer materials, thereby increasing (as opposed to laminar flow) the heat transfer potential between the air and the cooler wafer 4. For explanation purposes only, the air intake conduit 12 has a rectangular exterior cross-section with one of the planar exterior surfaces denoted as surface P, a substantial portion of which, 10 to 100 percent, is covered by CWTDs 2. In the exemplary embodiment, an array of two CP2-127-06L CWTDs 2 are used on side P, providing approximately 240 BTUs of cooling for the thermal energy exchanger 10. A heat sink 20 may also be mounted to the warmer wafer 6 of the CWTDs 2. The heat sink 20 may be machined to provide a planar surface that may abut the CWTDs 2, thereby sandwiching the CWTDs 2 between surface P and the heat sink 20. Electric fans 22 may also be mounted to the heat sinks 20 to assist with the dissipation of thermal energy by directing airflow over the heat sinks 20.

Referencing FIG. 1, assembly of the first exemplary embodiment of a thermal energy exchanger 10 may begin by positioning the CWTDs 2 so as to be in thermal communication with the air intake conduit 12 and the heat sink 20. The warmer wafers 6 are positioned to be in thermal communication with at least a portion of the heat sink 20, while the cooler wafers 4 are positioned to be in thermal communication with at least one exterior surface P of the air intake conduit 12. In the exemplary embodiment, the warmer wafers 6 are adjacent to, and in direct contact with the heat sink 20 while the cooler wafers 4 are adjacent to, and in direct contact with the air intake conduit 12. However, it is not necessary that any, or the entire surface of the warmer wafers 6 be in direct contact with the heat sink 20, nor that the cooler wafers 4 be in direct contact with the air intake conduit 12, so long as thermal communication is preserved. The heat sink 20 may thereafter be mounted to the air intake conduit 12 utilizing brackets 24; however, any chemical or mechanical technique, without limitation, such as employing a thermally conductive epoxy resin, adhesive or compression fitting, is acceptable for mounting the heat sink 20 to the air intake conduit 12, so long as the technique allows thermal communication between the warmer wafers 6 and the heat sink 20, as well as thermal communication between the air intake conduit 12 and the cooler wafers 4. Additionally, a fan 22 is mounted to the heat sink 20 to provide induced fluid currents over the heat sink 20 to thereby assist with dissipation of thermal energy from the heat sink 20. Each attached fan 22 is mounted to the heat sink 20 via screws 26; yet, any chemical or mechanical technique, without limitation, such as epoxy resin, adhesive or compression fittings may be appropriate so long as the means used for mounting is maintained.

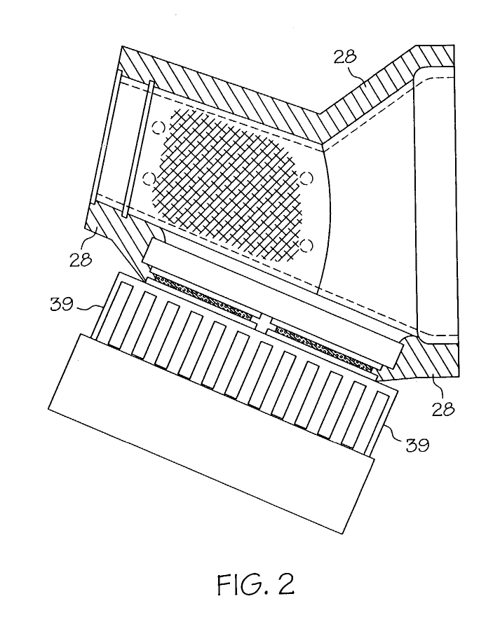

Optionally, as shown in the second exemplary embodiment of FIG. 2, insulation 28 may be utilized to insulate the exposed portions of the CWTDs 2 as well as exposed portions of the air intake conduit 12. The insulation 28 may be any type of insulation which withstands the conditions of intended use and is a poor conductor of thermal energy such as, depending on the circumstances and without limitation, foams (such as latex, stryofoam, polyurethane), glass wools, wood, plastics, rubbers, corks, glass, cotton and aerogels.

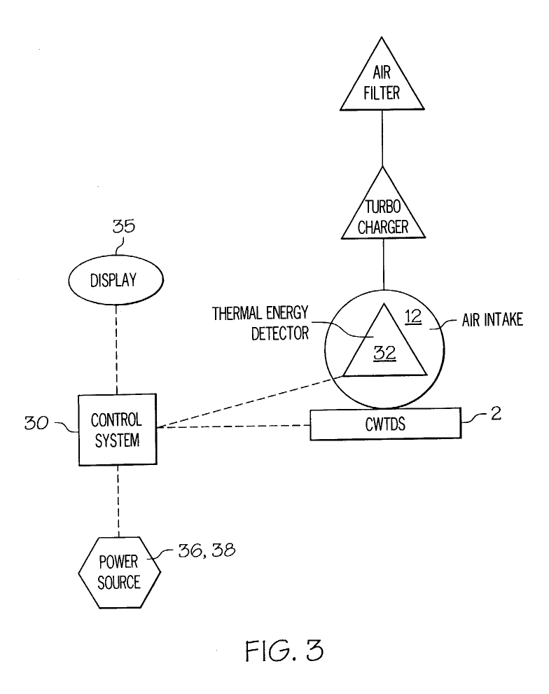

As shown in FIG. 3, a control system 30 may be provided to regulate the temperature of the air within the air intake conduit 12. The dashed lines between the units and the controller system 30 represent data connections, while the solid lines represent fluid connections between units. The control system 30, which is readily available to those of ordinary skill in the art, includes a thermal energy detector 32 within (or near) the air intake conduit 12 and power sources to power the CWTDs 2. Upon an appropriate signal being received from the thermal energy detector 32, indicating that the air within, or approximate the air intake conduit 12 is above a predetermined temperature, the control system 30 will be configured to apply power to the CWTDs 2, thereby cooling the air within the air intake conduit 12. The control system 30 may also manipulate a fluid control valve (not shown) should the heat sink have fluid conduits therein. Finally, the control system 30 may also include a temperature display 35 providing a user with a discernable indication as to what the temperature of the air is within the air intake conduit 12.

As will be apparent to those of ordinary skill, the control system 30 discussed above may be used with any of the thermal energy exchangers described or claimed herein. The control system 30 may also include more than one temperature sensor for providing temperature data on the air at various points within or near the air intake conduit. A manual switch (not shown) may also be provided to allow a user to power the thermal energy exchanger 10 when no control system 30 is present, or to override the control system 30 if necessary. The power sources may also be configured to supply continuous electrical power to the thermal energy exchanger 10 from a primary fixed power source 36, or an alternate power source 38 should the primary fixed power source 36 fail to provide the power necessary for the thermal energy exchanger 10 to adequately operate. Fixed power sources 36 include all batteries and other means which provide a DC source. Those of ordinary skill will appreciate that many other types of fixed power sources are available. It is also within the scope of the present invention that alternate power sources 38 providing an AC source may be teamed with converters that transform the AC source into a DC source.

The heat sink 20 and the heat transfer section(s) of air intake conduit 12 may be either a homogeneous or heterogeneous material, or combination of materials, having heat transfer properties characterized by being a good conductor of thermal energy. In the second exemplary embodiment (see FIG. 2), the heat sink 20 is machined aluminum having a plurality of fins 39, while the air intake conduit 12 is cast from aluminum. The air intake conduit 12 may also be constructed from a majority of insulative material(s), where only the region of the conduit that includes side P of the air intake conduit 12 is made of heat transfer material such as aluminum, thus allowing thermal communication with the CWTDs 2. It will be recognized by those of ordinary skill that other heat conductive materials and other heat sink designs than those shown could be utilized for, or in place of, the heat sinks 20 to provide or improve upon the overall heat transfer without departing from the spirit and scope of the present invention.

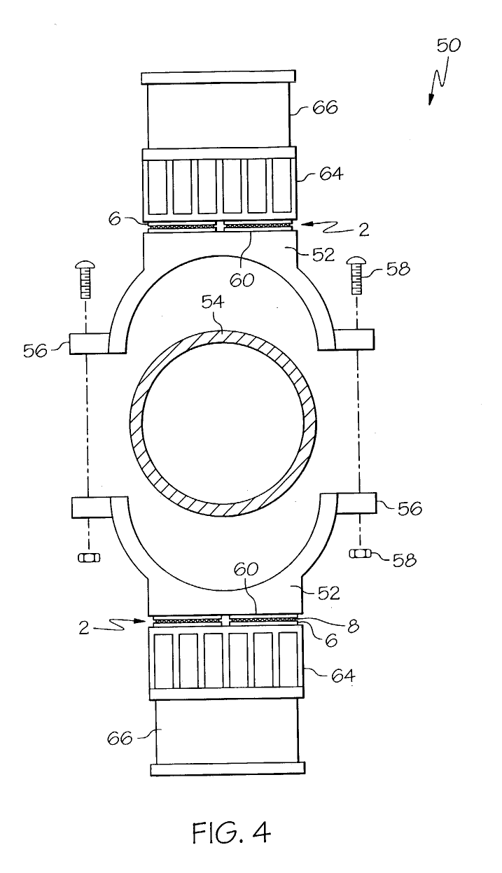

As shown in FIG. 4, a third exemplary embodiment of a thermal energy exchanger 50, according to the present invention, includes a pair of semi-tubular clamps 52 made from a heat transfer material that are adapted to mate with one another about a tubular air intake conduit 54. The clamps include diametrically opposed radial lobes 56 extending therefrom at the arcuate ends of the semi-tubular sections, where the lobes 56 include bolt-receiving holes extending therethrough (not shown) that allow fastening assemblies, such as bolt and nut assemblies 58, to couple the opposing clamps 52 together about the air intake conduit. Each clamp 52 also includes a segment 60 having a planer outer surface for receiving the cooler wafers of the CWTDs 2 thereon. A heat sink 64 is mounted against the opposite side (against the warmer wafers 6) of the CWTDs, thereby sandwiching the CWTDs 2 between the heat sink 64 and the clamp 52. A fan 66 is also mounted in proximity to the heat sinks 64 to provide induced air currents against the heat sink to help dissipate thermal energy absorbed therefrom.

Thermal energy is exchanged between the air and the interior surface of the air intake conduit 54 as the air flows through air intake conduit 54. The wafers 4 provide a driving force for the movement of thermal energy in the direction of the wafer surface, thus drawing thermal energy through the air and, in sequence, the air intake conduit 54. As thermal energy is being drawn through the air and through the air intake conduit, the CWTDs 2 function to pump this thermal energy, as well as the thermal energy generated by the resistance to current flow through the semiconductor blocks 8, to the warmer wafer 6. Thereafter, the thermal energy is conveyed from the warmer wafer 6 to the heat sinks 64 that dissipate the thermal energy to the environment.

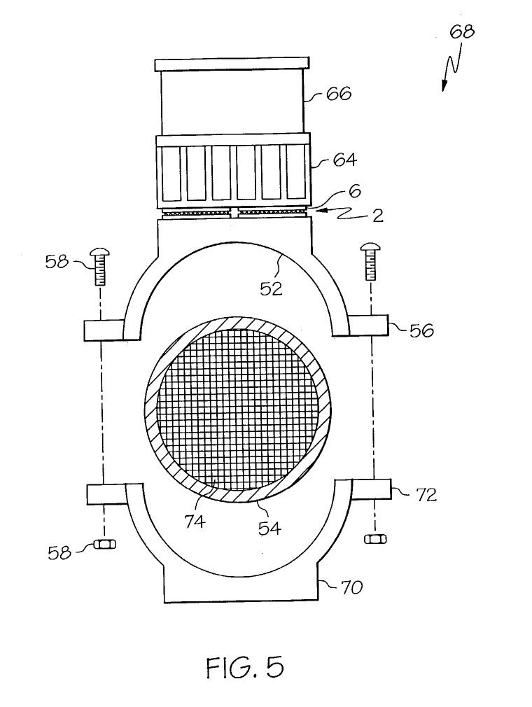

FIG. 5 shows a fourth exemplary embodiment of a thermal energy exchanger 68, according to the present invention, which includes only a single semi-tubular clamp 52 that mounts about the air intake conduit 54 using a semi-tubular support clamp 70 having diametrically opposed, radially extending lobes 72 for mating with the lobes 56 of the heat transfer clamp 52. This embodiment also illustrates the use of a mesh 74 of heat exchange material provided within the conduit 54 to help provide turbulent airflow within the conduit 54 and to increase the surface area of heat transfer materials in contact with the air flowing through. The single heat exchange clamp 52, according to the present embodiment, is assembled identically to the heat exchange clamps 52 provided in the third exemplary embodiment as shown in FIG. 4.

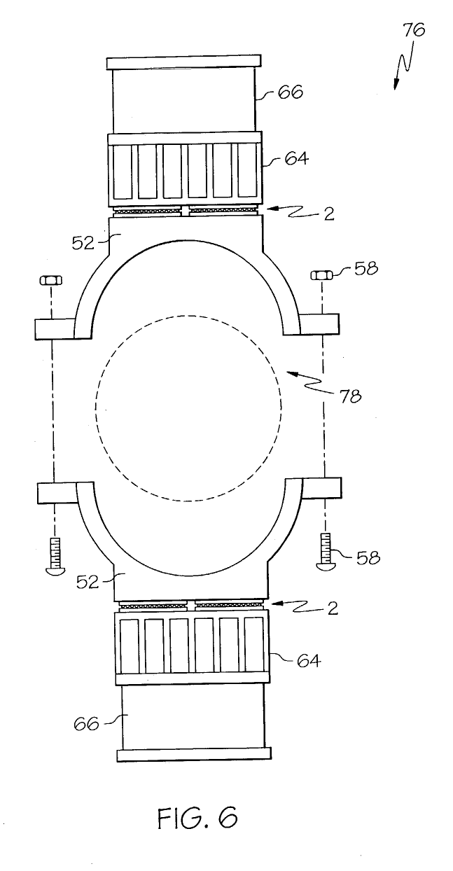

As shown in FIG. 6, a fifth exemplary embodiment 76, according to the present invention, is substantially similar to the third exemplary embodiment as shown in FIG. 4, except for the pair of clamps 52, when mated with one another, form their own conduit section 78. They may be mounted in line with an existing air intake section, for example. As within the fourth exemplary embodiment 68 shown in FIG. 5, it may be desirable to incorporate a mesh of a heat transfer material between the mating clamps 52 to provide turbulent air flow and increase the surface area available for heat transfer between the heat transfer materials and the air flowing therepast.

It is to be understood that in each alternate exemplary embodiment shown in FIGS. 4-6, it is not necessary that any, or the entire surface of the cooler wafers 4 be in direct contact with the air intake conduit 54 or the heat transfer clamps 52, 70, nor that the warmer wafers 6 be in direct contact with the heat sinks 64, so long as thermal communication is preserved. The CWTDs 2 may be secured to the air intake conduit 54, heat transfer clamps 52 and the heat sinks 64 by any chemical or mechanical technique, without limitation, such as epoxy resin or compression fittings which allows for thermal communication between the air intake conduit 54, heat transfer clamps 52 and the heat sinks 64 and their respective cooler 4 and warmer wafers 6 of the CWTDs 2.

It is also to be understood that the heat transfer clamps may be machined, forged, cast into various shapes to accommodate pre-existing air intake conduits or may be mounted to one another to create an air intake conduit having varied cross sections. It is also within the scope of the present invention that a single heat transfer block have one of more openings through which air might flow, thus effectively creating a single or a plurality of fluid conduits therethrough.

The heat sinks 64, air intake conduit 54, mesh 74 and heat transfer clamps 52, 70 may be either a homogeneous or heterogeneous material, or combination of materials, having heat transfer properties characterized by being a good conductor of thermal energy. In particular, the mesh 74 may be a wire mesh or a series of metallic pieces suspended within the airflow, but at some point making contact with the air intake conduit 54 so as to be in thermal communication with the cooler wafers 4. In the third, forth and fifth exemplary embodiments, the heat sink 64 is machined aluminum, the air intake conduit 54 is cast aluminum and the heat transfer clamps 52, 70 are cast aluminum. It will be recognized by those of ordinary skill that other heat conductive materials and other heat sink designs than those shown could be utilized for, or in place of, the heat sinks to provide or improve upon the overall heat transfer without departing from the spirit and scope of the present invention. In an exemplary embodiment, the heat sinks may have fluid conduits therethrough that are in fluid communication with the cooling system of the engine or a separate cooling system to dissipate thermal energy emanating from the warm wafers.

The thermal energy exchangers of the exemplary embodiments described herein may be retrofitted to current internal combustion systems, or may be designed and assembled with new internal combustion systems. As will be apparent to those of ordinary skill, other materials having good heat transfer properties may be used in place of the materials described above. In an exemplary situation, an additional heat transfer material may be positioned in any manner between the surfaces of the air intake conduit such that thermal communication can occur between the air intake conduit and a surface of the CWTD. These so-called heat transfer materials may be machined or molded to better mate with the exterior geometries of the vessel or conduit.

While the above exemplary embodiments have been explained in terms of cooling air within the air intake of an internal combustion engine, it is also within the purview of the present invention that other fluids directed to the combustion chamber may be cooled such as, without limitation, nitrous oxide, oxygen, hydrogen or other compositions of gases entering the combustion chamber of an internal combustion engine.

As a caveat to the heat transfer materials discussed above, it will be well understood by those skilled in the art that aluminum has a relatively high thermal conductivity (117 Btu/h·ft·° F. at 24° F.) as compared to other metals such as mild steel (26 Btu/h·ft·° F. at 24° F.) and cast iron (22 Btu/h·ft·° F. at 68° F.). While aluminum's higher thermal conductivity makes it more advantageous to use as a material through which heat or thermal energy will travel, other materials could certainly be used such as cast iron, copper (224 Btu/h·ft·° F. at 24° F.), or more expensive materials such gold (169 Btu/h·ft·° F. at 68° F. ) and silver (242 Btu/h·ft·° F. at 24° F.). For the purposes of this invention, therefore, a heat transfer material includes any material (metallic or non-metallic) having a suitable thermal conductivity for allowing heat transfer between the CWTD(s) and the ingestible fluid as well as between the CWTD(s) and the heat sinks. While aluminum is called for in the exemplary embodiments, it will be appreciated that materials with lower or higher thermal conductivity may be suitable “heat transfer materials” for a given application.

Following from the above description and invention summaries, it should be apparent to those of ordinary skill in the art that, while the methods and apparatuses herein described constitute exemplary embodiments of the present invention, it is to be understood that the inventions contained herein are not limited to these precise embodiments and that changes may be made to them without departing from the scope of the inventions as defined by the claims. Additionally, it is to be understood that the invention is defined by the claims and it not intended that any limitations or elements describing the exemplary embodiments set forth herein are to be incorporated into the meanings of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. An apparatus for transferring thermal energy in relation to a gas traveling through a gas intake of an internal combustion engine, the apparatus comprising:
a gas intake conduit adapted to be utilized as a conduit for gas traveling to a combustion chamber of an engine;
at least one thermoelectric device having at least two surfaces, concurrently dissipating thermal energy on a warmer surface and absorbing thermal energy on a cooler surface, mounted in proximity to the gas intake conduit and providing thermal communication between the gas intake conduit and the cooler surface of the thermoelectric device; and
a heat sink in thermal communication with the warmer surface.

2. The apparatus of claim 1, wherein the gas intake conduit includes a portion that has an outer surface against which the cooler surface of the thermoelectric device abuts.

3. The apparatus of claim 1, further comprising a control system, the control system being configured to enable power to be provided to the thermoelectric device should the temperature of the gas traveling within the intake be detected above a predetermined temperature.

4. The apparatus of claim 1, further comprising an interface block of heat transfer material integral with an outer surface of the gas intake conduit, the interface block having an outer surface receiving the cooler surface of the thermoelectric device.

5. The apparatus of claim 1, further comprising a body of heat transfer material positioned within the gas intake conduit, the body of heat transfer material being in thermal communication with the gas intake and the cooler surface of the thermoelectric device.

6. The apparatus of claim 5, wherein the body of heat transfer material is a mesh of heat transfer material filling an axial section of the gas intake conduit.

7. The apparatus of claim 1, wherein the heat sink is at least one of:
a finned heat transfer material;
a conduit of heat transfer material adapted to provide a fluid traveling therethrough; and
a heat transfer material block having a fluid traveling proximal to a surface of the heat transfer material block.

8. The apparatus of claim 7, wherein:
the heat sink is a finned heat transfer material;
the heat sink is coupled to an interface block of heat transfer material, which is in thermal communication with the gas intake conduit; and
the thermoelectric device is positioned between the heat sink and the interface block such that the warmer surface faces the heat sink and the cooler surface faces the interface block.

9. The apparatus of claim 8, wherein the interface block is mounted to the gas intake conduit utilizing one of a welding attachment, an adhesive and an integral molding.

10. The apparatus of claim 8, further comprising:
a body of heat transfer material positioned within the gas intake conduit to be in thermal communication with the gas intake conduit and the cooler surface of the thermoelectric device.

11. The apparatus of claim 10, wherein the interface block comprises a first segment and a second segment, the first segment and second segment being mounted together so as to form a portion of the gas intake conduit.

12. The apparatus of claim 10, wherein the body of heat transfer material is a mesh of heat transfer material approximately filling an axial section of the gas intake conduit.

13. The apparatus of claim 12, further comprising convective means to provide fluid currents in proximity to the heat sink.

14. An apparatus for transferring thermal energy in relation to a gas traveling through a gas intake conduit of an engine, the apparatus comprising:
a first bank of thermoelectric devices having opposed cooling surfaces and heating surfaces, the cooling surfaces absorbing thermal energy while the heating surfaces are concurrently dissipating thermal energy;
a first interface block of heat transfer material adapted to be mounted in thermal communication with an inner surface of the gas intake conduit, the interface block having a surface receiving the cooling surfaces of the first bank of thermoelectric devices; and
a first heat sink mounted in thermal communication with the heating surfaces of the first bank of thermoelectric devices.

15. The apparatus of claim 14, wherein the first heat sink is at least one of:
a finned heat transfer material block;
a conduit of heat transfer material adapted to have a fluid traveling therethrough; and
a heat transfer material block having a fluid traveling proximal to a surface of the heat transfer material block.

16. The apparatus of claim 15, further comprising mounting means to mount the first interface block to the gas intake conduit.

17. The apparatus of claim 15, further comprising:
a second bank of thermoelectric devices, the second bank of thermoelectric devices having opposed cooling surfaces and heating surfaces, the cooling surfaces absorbing thermal energy while the heating surfaces are concurrently dissipating thermal energy; and
a second interface block of heat transfer material adapted to be mounted in thermal communication with an inner surface of the gas intake conduit, the second interface block having a surface receiving the cooling surfaces of the second bank of thermoelectric devices.

18. The apparatus of claim 17, further comprising a second heat sink mounted in thermal communication with the heating surfaces of the second bank of thermoelectric devices.

19. An apparatus for shifting thermal energy collateral to a flowing gas, the apparatus comprising:
a first bank of thermoelectric devices having opposed cooling surfaces and heating surfaces, the cooling surfaces absorbing thermal energy while the heating surfaces are concurrently dissipating thermal energy; and
a clamp mounted so as to enable thermal communication between the first bank of thermoelectric devices and a gas approaching a combustion chamber of an engine.

20. The apparatus of claim 19, further comprising a first heat sink mounted so as to be in thermal communication with at least one of the heating surfaces of the first bank of thermoelectric devices.

21. The apparatus of claim 20, wherein:
the clamp comprises at least two clamp segments mounted together to provide at least one of: (a) a sleeve at least partially surrounding a gas conduit and (b) an axial portion of a gas conduit.

22. The apparatus of claim 21, wherein:
the clamp segment includes at least a first and second segment;
the first and the second clamp segments are oriented as to at least partially surround the gas conduit;
the first clamp segment has at least one exterior surface juxtaposed with at least one exterior surface of the gas conduit; and
the second clamp segment has at least one exterior surface juxtaposed with at least one exterior surface of the gas conduit.

23. The apparatus of claim 22, wherein the first clamp segment is mounted to the second clamp segment by at least one of a compression fitting, a weld and an adhesive; and the apparatus further comprises a convective means to provide fluid currents in proximity to the first heat sink.

24. The apparatus of claim 23, wherein the first clamp segment and the second clamp segment each have a semicircle exterior surface such that when the first clamp segment is mounted to the second clamp segment, a gas conduit is formed therebetween.

25. The apparatus of claim 24, wherein:
the clamp comprises at least two clamp segments mounted together to provide at least one of: (a) a sleeve at least partially surrounding a gas conduit and (b) an axial portion of a gas conduit;
the first bank of thermoelectric devices are mounted to the first clamp segment; and
the second bank of thermoelectric devices are mounted to the second clamp segment.

26. The apparatus of claim 25, further comprising convective means to generate fluid currents past the first heat sink and the second heat sink, and wherein:
the first clamp segment is mounted to the second clamp segment and oriented so as to form a gas conduit therebetween;
the first heat sink is in thermal communication with heating surfaces of the first bank of thermoelectric devices; and
the second heat sink is in thermal communication with the heating surfaces of the second bank of thermoelectric devices.

27. The apparatus of claim 26, further comprising a web of heat transfer material approximating the cross-section of the gas conduit and in thermal communication with the internal surface of the gas conduit, so as to transfer thermal energy between the gas flowing through the gas conduit and the cooler surfaces of the first bank and second bank of thermoelectric devices.

28. The apparatus of claim 27, wherein the first and the second clamp segments are in the general shape of semi-circles or elliptical sections.

29. The apparatus of claim 19, further comprising a second bank of thermoelectric devices having opposed cooling surfaces and heating surfaces, the cooling surfaces absorbing thermal energy while the heating surfaces are concurrently dissipating thermal energy.

30. The apparatus of claim 29, further comprising a second heat sink mounted so as to be in thermal communication with at least one of the heating surfaces of the second bank of thermoelectric devices.

31. A method for transferring thermal energy in relation to a gas traveling through a gas intake to an engine, the method comprising the steps of:
providing at least one thermoelectric device having at least two surfaces, concurrently dissipating thermal energy on a warmer surface and absorbing thermal energy on a cooler surface when powered;
positioning the thermoelectric device to be in thermal communication with a gas intake conduit for the engine; and
providing power to the thermoelectric device to establish a thermal gradient between a gas within the gas intake conduit and the cooler surface of east the one thermoelectric device.

32. The method of claim 31, further comprising the steps of:
mounting the thermoelectric device such that the cooler surface is in thermal communication with the gas intake conduit; and
providing a heat sink to be in thermal communication with at least the warmer surface of the thermoelectric device;

33. The method of claim 32, further comprising the steps of supplying a flowing fluid in proximity to the heat sink to dissipate thermal energy from the heat sink.

34. The method of claim 33, wherein the heat sink is at least one of:
a finned heat transfer material,
a block of heat transfer material having a fluid conduit traveling therethrough, and
a conduit of heat transfer material having a heat transfer fluid traveling therethrough.

35. The method of claim 34, further comprising the steps of:
sensing the gas temperature in the gas intake conduit; and
providing power to the thermoelectric device when the gas temperature is detected to be above a predetermined temperature.

36. The method of claim 32, further comprising the step of increasing the surface area of heat transfer material in thermal communication with the cooler surface of the thermoelectric device and the gas intake conduit.

37. A method for transferring thermal energy in relation to a gas traveling through a gas intake of an engine, the method comprising the steps of:
providing a gas intake conduit for gas flowing to a combustion chamber of an internal combustion engine;
providing at least one thermoelectric device having at least two surfaces, concurrently dissipating thermal energy on a warmer surface and absorbing thermal energy on a cooler surface when powered;
mounting the thermoelectric device such that the cooler surface is in thermal communication with the gas intake conduit;
providing a heat sink to be in thermal communication with at least the warmer surface of the thermoelectric device;
supplying a flowing fluid in proximity to the heat sink; and
providing power to at least the one thermoelectric device to establish a thermal gradient between a gas within the gas intake conduit and the cooler surface of at least the one thermoelectric device.

38. A method for transferring thermal energy from a gas traveling downstream from a turbocharger of a combustion system, the method comprising the steps of:
providing at least one thermoelectric device having at least two surfaces, concurrently dissipating thermal energy on a warmer surface and absorbing thermal energy on a cooler surface when powered;
positioning the thermoelectric device to be in thermal communication with a gas intake conduit section downstream from the turbocharger of the combustion system; and
providing power to at least the one thermoelectric device to establish a thermal gradient between a gas within the downstream section of the gas intake conduit and the cooler surface of at least the one thermoelectric device.

39. The method of claim 38, further comprising the steps of:
mounting the thermoelectric device such that the cooler surface is in thermal communication with the gas intake conduit section; and
providing a heat sink to be in thermal communication with at least the warmer surface of the thermoelectric device;

40. The method of claim 39, further comprising the steps of supplying a flowing fluid in proximity to the heat sink to dissipate excess thermal energy from the heat sink.

41. The method of claim 40, wherein the heat sink is at least one of:
a finned heat transfer material,
a block of heat transfer material having a fluid conduit traveling therethrough, and
a conduit of heat transfer material having a heat transfer fluid traveling therethrough.

42. The method of claim 41, further comprising the steps of:
sensing the gas temperature in the gas intake conduit section; and
providing power to the thermoelectric device when the gas temperature within the gas intake conduit section is detected to be above a predetermined temperature.

43. The method of claim 39, further comprising the step of increasing the surface area of heat transfer material in thermal communication with the cooler surface of the thermoelectric device and the gas intake conduit section.

44. A method for transferring thermal energy from a gas traveling upstream from a combustion section of an internal combustion engine, the method comprising the steps of:
providing at least one thermoelectric device having at least two surfaces, concurrently dissipating thermal energy on a warmer surface and absorbing thermal energy on a cooler surface when powered;
positioning the thermoelectric device to be in thermal communication with a gas intake conduit section upstream from the combustion section of the internal combustion engine; and
providing power to thee thermoelectric device to establish a thermal gradient between a gas within the upstream section of the gas intake conduit and the cooler surface of the thermoelectric device.

45. The method of claim 44, further comprising the steps of:
mounting the thermoelectric device such that the cooler surface is in thermal communication with the gas intake conduit section; and
providing a heat sink to be in thermal communication with at least the warmer surface of the thermoelectric device;

46. The method of claim 45, further comprising the steps of supplying a flowing fluid in proximity to the heat sink to dissipate excess thermal energy from the heat sink.

47. The method of claim 46, wherein the heat sink is at least one of:
a finned heat transfer material,
a block of heat transfer material having a fluid conduit traveling therethrough, and
a conduit of heat transfer material having a heat transfer fluid traveling therethrough.

48. The method of claim 47, further comprising the steps of:
sensing the gas temperature in the gas intake conduit section; and
providing power to the thermoelectric device when the gas temperature within the gas intake conduit section is detected to be above a predetermined temperature.

49. The method of claim 45, further comprising the step of increasing the surface area of heat transfer material in thermal communication with the cooler surface of the thermoelectric device and the gas intake conduit section.

50. A method for transferring thermal energy from a gas traveling upstream from a combustion section of a vehicle combustion system, the method comprising the steps of:
providing a gas intake conduit upstream from a combustion system of a vehicle combustion system for directing a gas into the combustion section;
providing at least two thermoelectric devices, each having at least two surfaces, concurrently dissipating thermal energy on a warmer surface and absorbing thermal energy on a cooler surface when powered;
mounting the thermoelectric devices such that the cooler surfaces are in thermal communication with the gas intake conduit;
providing at least a first heat sink to be in thermal communication with the warmer surface of at least one of the thermoelectric devices;
supplying a flowing fluid in proximity to the heat sink; and
providing power to the thermoelectric devices to establish a thermal gradient between the gas within the gas intake conduit and the cooler surface of the thermoelectric device.

51. The method of claim 50, wherein the step of providing a gas intake conduit includes the steps of:
assembling segments of heat transfer material so as to construct at least a portion of the gas intake conduit;
mounting the heat transfer material segments making up the portion of the gas intake conduit in-line with an existing portion of the gas intake conduit; and
sealing any intersections between the portion of the gas intake conduit assembled from heat transfer material segments and existing portions of the gas intake conduit;
wherein the thermoelectric devices are mounted to at least one of the heat transfer material segments.

52. The method of claim 51, wherein the step of assembling segments includes providing at least two segments of heat transfer material having semi-circle exterior features such that when assembled, the portion of the gas intake conduit is formed.

53. A method for transferring thermal energy in relation to a gas traveling through a gas intake to an internal combustion engine, comprising the steps of:
providing at least one thermoelectric device having at least two surfaces, concurrently dissipating thermal energy on a warmer surface and absorbing thermal energy on a cooler surface; and
establishing a thermal gradient between the gas within the gas intake to the internal combustion engine and the cooler surface of the thermoelectric device.

54. The method of claim 53, further comprising the step of:
dissipating thermal energy from the warmer surface of the thermoelectric device.
